(19) United States
(12) Patent Application Publication
(10) Pub. No.: US 2013/0205343 A1
(43) Pub. Date: Aug. 8, 2013

(54) Method & Apparatus for an Enhanced Television Viewing Experience

(71) Applicant: John J. KIRBY, Portland, OR (US)

(72) Inventor: John J. KIRBY, Portland, OR (US)

(21) Appl. No.: 13/365,911

(22) Filed: Feb. 3, 2012

(51) Int. Cl. H04N 21/84

(52) U.S. Cl. 725/51

(57) ABSTRACT

Embodiments of the invention include methods and systems to provide an enhanced television experience via a receiver that can access both broadcast and Internet content and can combine elements from both into a single enhanced display. Broadcast-delivered and Internet-delivered content elements are aligned in context by extending the data in an electronic program guide to include an Internet Universal Resource Locator (“URL”) for each program. The URL is used by the receiver to access the supplemental content on the Internet corresponding to a specific broadcast program.

### PRIORITY CLAIM

This is an original patent application.

### FIELD

This invention is a method to enhance the television broadcast viewing experience by augmenting the traditional television video presentation with supplemental and optionally-interactive data in various forms, including but not limited to: text, pictures, graphics, supplemental video and applications. The television broadcast audio experience may be enhanced by supplemental sound elements as well.

### BACKGROUND

The concept of enhanced or interactive television has been envisioned for several decades. There have been various implementations in which data that supplements a broadcast program has been made available to a television viewer. Generally, the supplemental data is sent to the receiving end in one of two ways: (1) “in-band”, meaning that the data is sent within the broadcast signal, and (2) “out-of-band”, meaning that the data is sent by another transport mechanism.

### In-Band Transmission of Supplemental Data

One simple example of in-band transmission of supplemental data is the Closed Captioning system which displays a limited textual representation of the broadcast audio—for example, performer dialog—on the television screen along with the broadcast video image.

Another example of in-band transmission of supplemental data was Intercast™. This system, released in 1996, was not commercially well-received and consequently abandoned shortly thereafter.

Intercast was developed by Intel Corporation and primarily productized by PC card vendor Hauppauge. Deployments were done with the cooperation of NBC, ESPN, MTV, HGTV and a limited number of other content providers.

The system created an enhanced TV-like experience on a personal computer (PC) that was equipped with a special TV tuner card. A limited number of Intercast pages corresponding to a particular television broadcast program, were developed by a team at each participating network. These Intercast pages were encoded and transmitted to the receiver in-band within the broadcast television signal within an unused portion of the video signal known as the Vertical Blanking Interval.

The transmission speed of the supplemental data, since it was sent in the Vertical Blanking Interval, was very limited—approximately 10 kilobits per second. And since the data was transmitted in-band with the television signal, it was subject to the technical and business-related limitations and risks that are described below.

The Intercast tuner card had a broadcast television input along with internal circuitry that extracted the Intercast pages from the Vertical Blanking Interval, combined the video with the supplemental data, and showed the combined image on the PC display.

It was possible for an Intercast page developer to include a link in an Intercast page that pointed to a web site on the Internet. However, since the in-band delivery path of the supplemental data was only one-way from broadcaster to receiver, an Internet connection was required for the receiver to access the corresponding Internet address. Also, since nearly all Internet connections at the time were via 56 k-baud modems using phone lines, the connection was slow, and more significant, it required users to not use their telephones when watching an enhanced program if that Internet capability was to be utilized. Consequently, this Internet back-channel capability was rarely exploited by the broadcasters.

The supplemental data in Intercast was linked in context with the television programming by the fact that the data was supplied in-band along with the broadcast signal and could therefore be readily associated with the broadcast programming.

Intercast was deployed when the NTSC (National Television System Committee) broadcast transmission standard was in use in the United States, and as described above, supplemental data was passed in the NTSC signal's Vertical Blanking Interval. Under the new ATSC (Advanced Television Systems Committee) digital television broadcast standard in the US, enhanced television broadcasters using in-band transmission of supplemental data now send their supplemental data as digital packets in the broadcast signal along with the packets containing the digital audio/video broadcast content. In some systems, the supplemental data is formatted according to the EBIF (Enhanced TV Binary Interchange Format) specification developed as part of the OpenCable project of Cable Television Laboratories, Inc.

Advantages of in-band transmission of supplemental data via either NTSC or ATSC methods are: (1) the receiver only needs a broadcast input to acquire both the broadcast audio/video content and the supplemental data content, and (2) the broadcast data and supplemental data may be more easily associated in context since they arrive at the same time via the same signal.

However there are fundamental disadvantages of in-band transmission of supplemental content by either the NTSC or ATSC transports. Those disadvantages include:

(1) Transmitting the supplemental data in-band within the broadcast television signal requires the broadcaster to provide the technology that combines the supplemental data and the broadcast content in the same signal prior to transmission.

(2) Over-the-air, cable and satellite television transmission facilities that desire to pass the additional in-band supplemental content must have the infrastructure and capabilities necessary to do so.

(3) Downstream television affiliates, television cable operators or satellite operators have the option to remove this in-band supplemental information unless additional compensation is provided by the originating broadcaster or content owners, thereby potentially creating additional costs for the originating broadcaster or content owners to deliver the supplemental data to viewers.

(4) The cost and complexity of the receiver are increased so that the in-band data may be received and processed.

(5) Broadcasters/content providers need to create and encode the supplemental data in not-widely-used EBIF or similar format.

(6) Broadcasters/content providers likely need to create a separate service or hosting environment that is appropriate for in-band transmission of supplemental content.

(7) Broadcasters/content providers typically have a web presence and an existing web creation staff in place. However for transmission of supplemental content for in-band transmission, the staff needs to acquire additional skills to create content in a format that complies with specifications such as EBIF for in-band delivery of the supplemental content.

### Out-of-Band Transmission of Supplemental Data

As mentioned above, the other common method of providing a television viewer with supplemental data is to send that data “out of band”, meaning that it is sent to the receiving end by a transport mechanism other than the broadcast signal.

A common embodiment of this method is where a television network provides a web site targeted to their viewers. For example, the NBC Television Network has a web site (www.nbc.com) that contains sets of web pages associated with various television programs appearing on their television network, and users seated near a television, can access this web content via the Internet on their personal computer, laptop computer, or special-purpose device while watching the associated TV program.

One key disadvantage to this approach is that there is “split attention” between two screens. The viewer watches the television program on the TV display and views information related to the program separately on the nearby Internet-connected device.

Another key disadvantage of this approach is that there is no automatic mechanism for the user to find and access the related supplemental content on the Internet. The user must look for the content, perhaps prompted by a graphic that appears in the program or by verbal directions from the program performers.

Another method for out-of-band delivery of supplemental content involves Internet-ready televisions. Vendors including Sony and Samsung have recently begun shipments of these appliances which have both broadcast and Internet connectivity. The Internet connection allows users to access web information directly on their television screen and consequently eliminates the problem of requiring the user to “split attention” between two screens as mentioned above.

In one usage scenario for Internet-ready TVs, the user would access the Internet without regard to broadcast content being viewed. That is, the web content does not contextually supplement the broadcast content. For example while watching an entertainment program in one window on the TV monitor, the user might view a weather-related web site in another window on the monitor. Consequently, although this is perhaps a valuable experience for the viewer, the result is not a contextual enhancement of the television programming being viewed.

In another usage scenario for an Internet-ready TV, a user might go to an Internet movie site and download or stream a movie for viewing on the television screen. Although movie-watching is a valuable experience for some viewers, it is equivalent to passively viewing a television broadcast since no enhancing supplemental data is presented.

In another usage scenario for an Internet-ready TV, the user might choose to access web content that is related to a broadcast program being viewed. For example, while watching NBC's Tonight Show, the user might access the Tonight Show's web pages on www.nbc.com. However, a key disadvantage is that even if the viewer presumes that associated content may be found at www.nbc.com, the viewer needs to find the supplemental content appropriate for that particular moment of that particular episode of the Tonight Show on www.nbc.com. Access to the specific optimal supplemental content is not automated.

Another disadvantage is that even if the viewer finds the optimal Internet content for the broadcast program being viewed, the broadcast-delivered and web-delivered content are presented in distinct windows on the single television display. For aesthetic, contextual, usability and business/advertising reasons, it would be preferable to have the broadcast video and Internet-delivered elements combined into a single, specifically-designed representation on the single enhanced television monitor.

In yet another usage scenario for an Internet-ready TV, rather than relying on typical broadcast transports including terrestrial signal, television cable or satellite to deliver the broadcast content to a receiver, an Internet content provider could deliver an audio/video broadcast stream, equivalent to a television broadcast, to an Internet-ready television via the Internet. This audio/video broadcast stream could be combined with supplemental data at the content provider end into a single representation which would then be sent to all of the Internet devices or Internet-ready TVs viewing the program.

A disadvantage of this approach is that an extremely significant amount of Internet bandwidth and Internet server capacity is required to send a broadcast audio/video stream that is comparable in quality and fidelity to a typical high-definition television broadcast audio/video signal from the Internet server(s) to all receivers.

Finally, speaking generally about past and current embodiments of enhanced television, another disadvantage of those embodiments is that the audio experienced is typically not enhanced. That is, elements of the broadcast content are not typically augmented by supplemental audio supplied by either in-band or out-of-band means.

The invention described in this disclosure corrects the various deficiencies of past and current embodiments described above.

### SUMMARY

The invention provides a method where an enhanced television viewing experience may be presented to a viewer via a receiver/monitor system that has the capability of receiving both typical broadcast audio-video content via standard broadcast methods as well as accessing related data (supplemental data) on the Internet and displaying a combination of both elements, on an automatically-contextually-linked basis, to the viewer on a single enhanced television viewing monitor.

Such supplemental data, provided by a Supplemental Data Content Provider, might be constructed as a hierarchy of Data Pages similar to a hierarchy of web pages on a traditional Internet web site and hosted on the Internet in the same manner as typical web pages. There would typically be a specific page, the Main Data Page, associated with a specific program which the receiver would initially access when the viewer selects that program to view.

The Data Pages, similar to Internet web pages, could contain items such as text, graphics, pictures, applications, applets, plug-ins, audio elements, video elements or other data elements, and those pages would also specify the placement, size and other characteristics of those items when rendered on a monitor. Specific examples of such items are sports statistics in the form of text and/or graphics, pictures of sports personalities, voting capabilities or even supplemental streaming video and audio. Similar to traditional Internet web pages, the format and placement of data in the resulting display would be completely flexible as envisioned and constructed by the page author.

Each Data Page would also typically specify a placeholder location (“video hole cutter”) in the page where the receiver is instructed to place (composite) the broadcast video, received by broadcast means, within the page when displayed to the viewer. The location of the video hole cutter in each Data Page would be under the control of the page author.

A program guide is presented to the viewer on the monitor to select the program to be viewed. In addition to the data typically included in the program guide, such as the program name and broadcast channel for each program, the program guide would be augmented to also include, for each program, the Internet address (URL) of the Main Data Page, described above, which the receiver's Internet access mechanism would initially access when the viewer selects that particular program to view.

Just as a computer user interacts with web pages on a computer, the television viewer using this invention would optionally be able to interact with, and navigate through, the set of Data Pages related to the television program they are viewing, with each page typically including the broadcast video that is placed within the page as specified by the “hole cutter” in that specific page. At the discretion of the Data Page author, the page could also contain links which reference pages, data and other resources located elsewhere on the Internet.

In addition to providing supplemental data in visual form (text, pictures, graphics, streaming video, et cetera), a Supplemental Content Provider could also optionally provide data in the form of audio. In this case, the supplemental audio, if desired by the user, would be presented to the user via speakers on the receiver or on an associated audio system. Such supplemental audio might be presented to the television viewer in lieu of, or mixed with, the broadcast audio signal.

This invention therefore provides an enhanced television viewing experience that addresses and eliminates the disadvantages and deficiencies of prior and current approaches, specifically:

(1) The supplemental data is delivered out-of-band via the Internet, thereby side stepping the multiple problems related to in-band transmission of supplemental data as described previously.

(2) The supplemental data is relevant to the broadcast programming being seen by the viewer.

(3) The supplemental data is automatically matched in context with the broadcast content, thereby eliminating the need for the user to find the optimal, relevant supplemental content on the Internet.

(4) The supplemental data may be constructed and hosted using traditional methods routinely used for web-hosted content rather than being constructed and hosted as necessary for in-band transmission as required by the EBIF or similar standards. No significant additional skills or infrastructure other than that for standard web production and hosting are required.

(5) The supplemental data and broadcast content are presented on a single viewing device—the enhanced TV monitor—rather than having the broadcast video content presented on a TV monitor and the supplemental data being presented on a separate Internet device monitor.

(6) On that single enhanced TV monitor, rather than showing the broadcast video in one representation (one window) on the monitor and the supplemental data content in a separate representation (separate window) on that same monitor, the broadcast video and supplemental data are integrated into a single representation (single window) on the monitor where the layout of the combined representation in that window is controlled by the supplemental data content author. This results in a display that can be more aesthetically pleasing and operationally integrated, and may provide the content provider more advertising options and business potential.

(7) As opposed to embodiments which seek to send high quality/high resolution broadcast data to receivers via the Internet—requiring significant Internet server and bandwidth capacity—this invention uses traditional broadcast transmission and transport methods to deliver the broadcast audio and video components to the receiver.

(8) The supplemental data can include audio, thereby enhancing not only the user viewing experience but potentially the user audio experience as well.

### BRIEF DESCRIPTION OF DRAWINGS

Embodiments of this invention are illustrated by way of example and not by way of limitation in the figures of the accompanying drawings in which like references indicate similar elements. It should be noted that references to “an embodiment” or “one embodiment” in this disclosure are not necessarily to the same embodiment, and such references mean “at least one.”

FIG. 1, “Data Flow Overview”, shows an overview of the key elements, data items and data flows of the invention in a typical embodiment.

FIG. 2, “Supplemental Data and Related Data Flow”, shows additional detail regarding the data flow of supplemental data from content provider to receiver monitor in a typical embodiment.

FIG. 3, “Sample Augmented Program Guide and Related Data Flow”, illustrates the data flow of program guide information from program guide provider to receiver in a typical embodiment and shows the type of data (Main Data Page URLs) that is added to the internal data structures of the Augmented Program Guide for this invention.

FIG. 4, “Compositing and Display of Enhanced TV Image”, illustrates the compositing of broadcast video with supplemental data in the receiver, and the resulting display presented to the user on a monitor in a typical embodiment.

FIG. 5, “Compositing and Output of Enhanced Audio”, illustrates the combining of broadcast audio and supplemental audio in the receiver, and how the resulting audio is presented to the user in a typical embodiment.

FIG. 6, “Example Enhanced Displays”, shows an example set of enhanced displays presented to the user in a possible embodiment.

FIG. 7 shows a representative environment where an embodiment of the invention may be operated.

FIG. 8 outlines a method by which a television system can implement an embodiment of the invention.

Note that a given figure may show numbered data flows or items which are not specifically referenced in this specification. They are included to provide common references between that figure and similar items in other figures.

### DETAILED DESCRIPTION

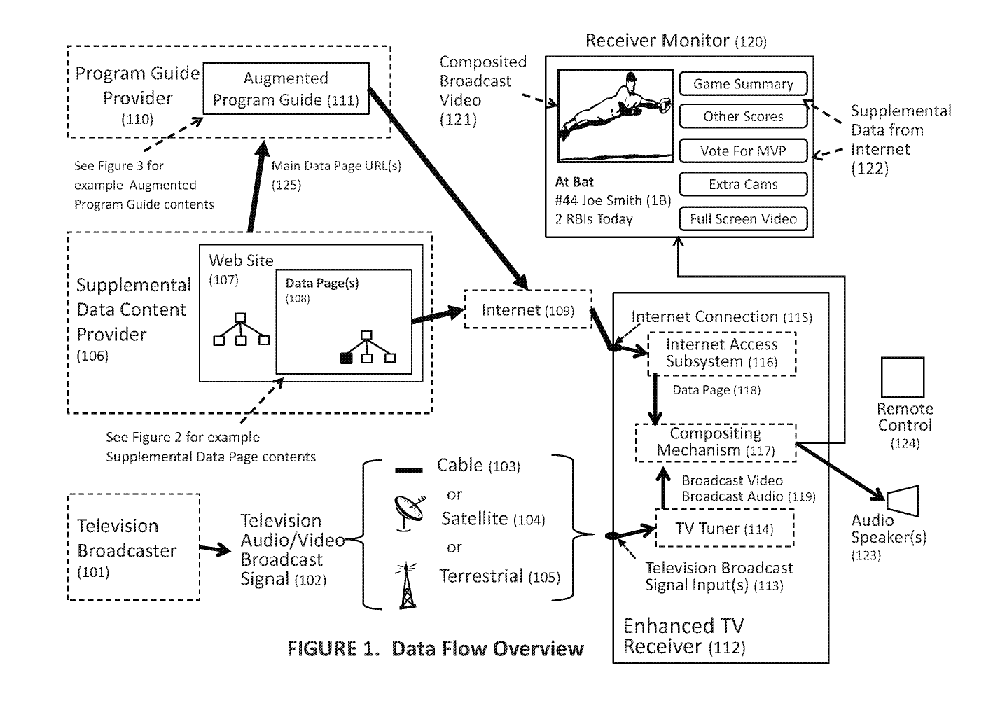

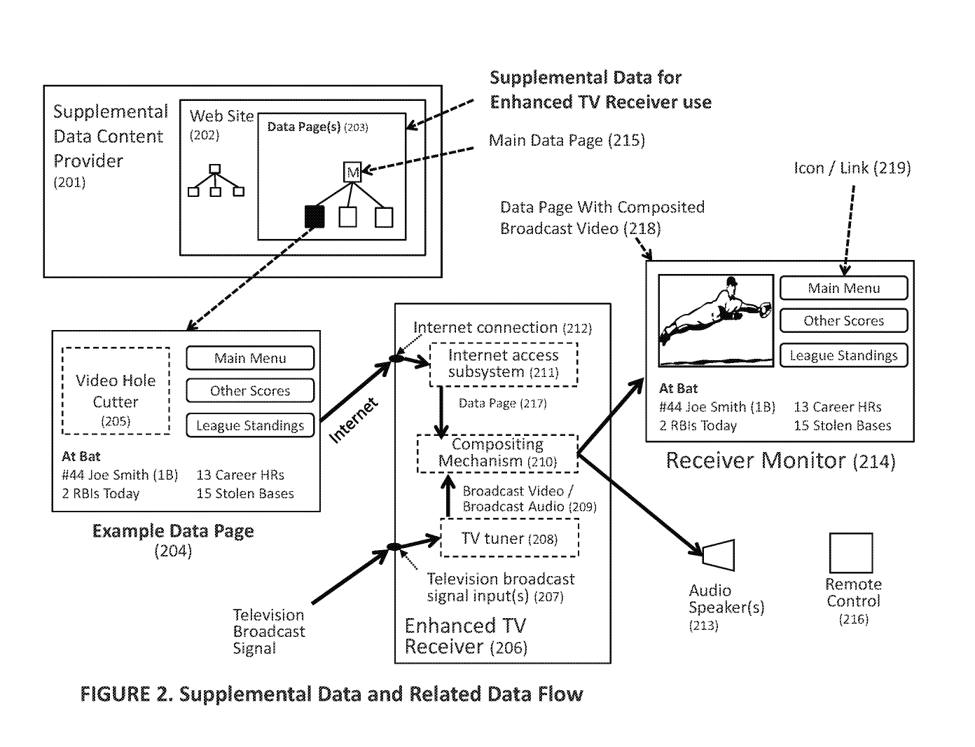

Note that references of the form (xxx) in this disclosure refer to a Figure and item number. For example, reference (103) refers to FIG. 1, item 103. Reference (209) refers to FIG. 2, item 209, et cetera.

Traditionally, a television broadcaster transmits a television program consisting of video and audio content to a television receiver using a broadcast signal. The receiver then displays the video image on a monitor and presents the broadcast audio on a speaker or audio subsystem.

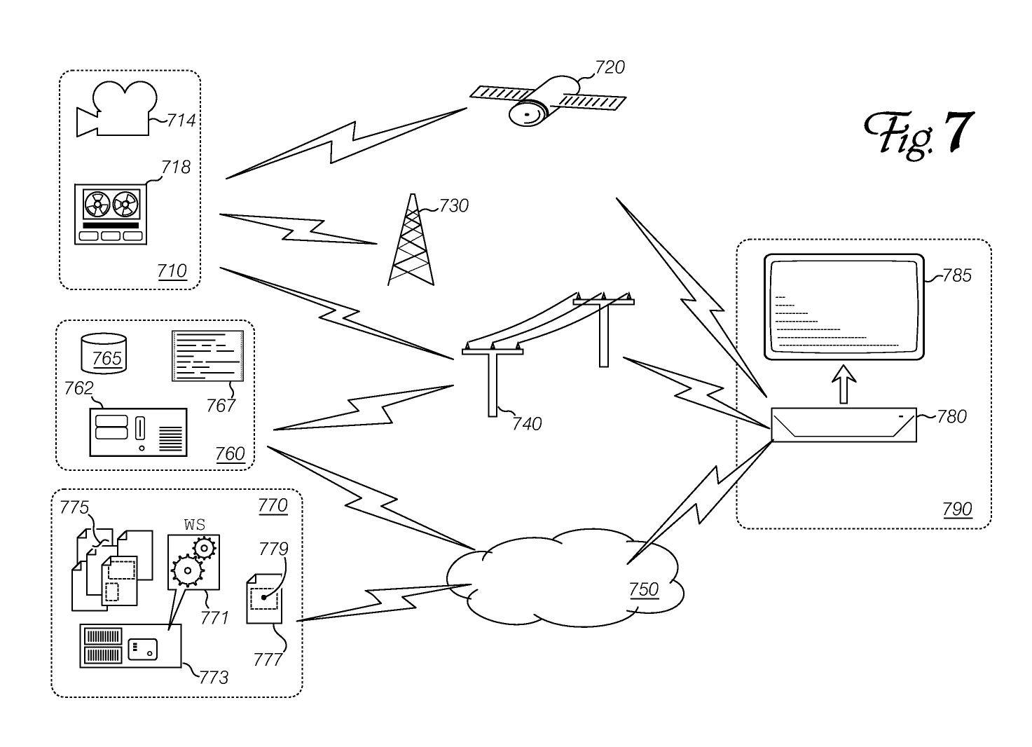

FIG. 7 shows a sample environment including such a traditional television broadcaster at 710, plus several other entities that participate in delivering the enhanced television viewing experience. Broadcaster 710 may produce an audio/video program signal using live video footage 714, recorded footage 718, or other traditional sources. This signal may be transmitted to viewers via satellite 720, terrestrial television signal 730, or cable systems 740.

An embodiment also requires the participation of a program guide provider 760, which may operate a computer system 762 and/or database 765 to collect information about program schedules, transmission channels, program content and reviews, etc. In an embodiment, the program guide data 767 which is transmitted to viewers includes a Uniform Resource Locator (“URL”), which can be used to obtain supplemental information from a standard website.

A final participant on the “source” side of an embodiment is a web site provider 770, which may include a web server 771 executing at a computer 773 and accessible via a distributed data network 750 such as the Internet. Web server 771 may make a number of data resources 775 available, such as HTML pages, images, sound and video files, and so on. In addition, in an embodiment, one or more data pages 777 which include a video hole-cutter region 779 (described below) are available from the web server 771.

At the viewer's side of an embodiment, a system 780 is able to receive a variety of signals (e.g., satellite or terrestrial broadcast signal, cable TV and/or Internet) and extract several different types of data therefrom. The following disclosure will refer to “logical data streams” to indicate that the receiver obtains a certain type of data, without regard to which signal (or which combination of signals, or which sub-channel of a multiplexed signal) actually carries the data. The principal types of data of interest in an embodiment are the audio/video data transmitted from a television broadcaster 710; the program guide data transmitted from a program guide provider 760; and the data pages sent by a supplemental data content provider 770.

System 780 accesses, receives, processes and combines the data as described below, and ultimately produces an image to be displayed to the viewer on a monitor 785. In some embodiments, system 780 may be a “set-top box” that is separate from monitor 785, while in other embodiments, all the functions of system 780 may be combined with monitor 785 as an all-in-one enhanced TV appliance 790.

FIG. 1 shows a more-detailed overview of the data flowing between systems participating in an embodiment. A Television Broadcaster (101), in the traditional way, transmits a Television Audio/Video Broadcast Signal (102) to an Enhanced TV Receiver (112) via a transmission media such as an over-the-air (“terrestrial”) signal (105), television cable (103) or satellite (104). However, in this invention, the receiver, an Enhanced TV Receiver (112), is not only capable of receiving the television broadcast signal via a Television Broadcast Signal Input(s) (113); it also contains an Internet Access Subsystem (116) and is connected to the Internet via an Internet Connection (115) and is therefore able to receive one or more Data Pages (108) from a Supplemental Data Content Provider (106) via the Internet (109) that enhance the broadcast content. It may access additional data and resources from other Internet sites as well (not shown).

Broadcast Video (119) is combined with supplemental data in the form of a Data Page (108, 118) by the Compositing Mechanism (117) and shown in combined form on the Receiver Monitor (120) which may or may not be physically integrated with the Enhanced TV Receiver (112).

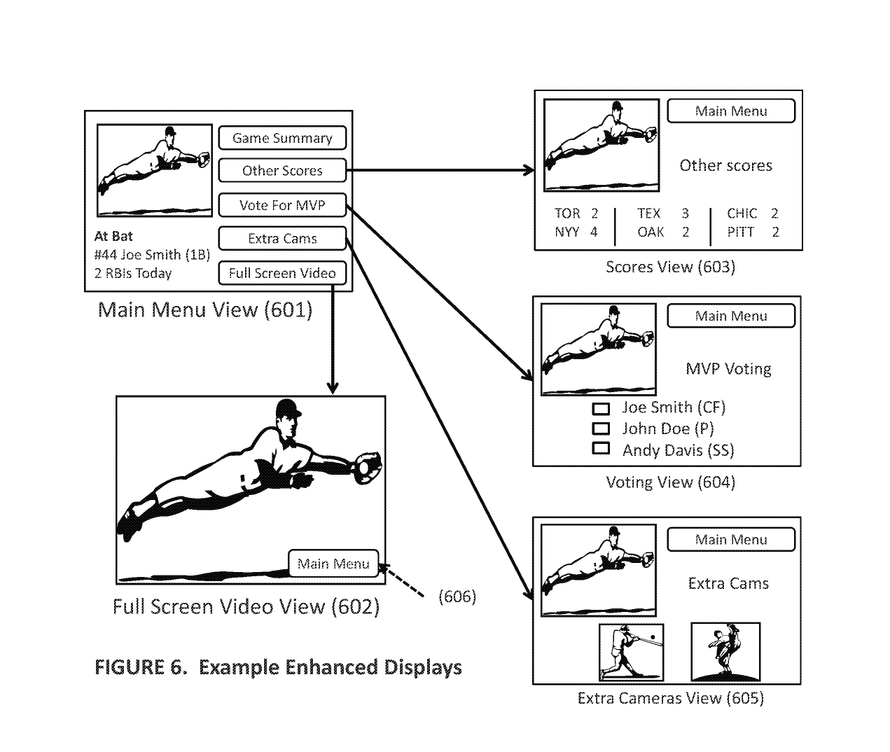

The result is an augmented, enhanced and optionally interactive television viewing experience on the Receiver Monitor (120) for the viewer since the monitor presents a display which is a combined representation of both the broadcast video and supplemental data content. Examples of possible displays are shown in FIG. 6, “Example Enhanced Displays.”

If a Data Page (108, 118) also includes audio elements, such audio may also be combined with Broadcast Audio (119) by the Compositing Mechanism (117) and presented to the user—either in lieu of or mixed with the broadcast audio content—on an Audio Speaker(s) (123) or an equivalent audio mechanism associated with the Enhanced Television Receiver (112).

The next few sections of this disclosure describe the supplemental data and related elements.

The supplemental data in the form of one or more Data Pages (108) is produced by the Supplemental Data Content Provider (106) which would likely, but not necessarily, be affiliated with the Television Broadcaster (101).

Currently, a Supplemental Data Content Provider (106) typically offers an Internet web site (107) to provide typical Internet users with information which augments the television programming provided by the Television Broadcaster (101). For example, the broadcast network NBC has a web site (www.nbc.com) which has sets of web pages associated with various television programs available on their television network. In this example, the NBC television network would be the Television Broadcaster (101), and NBC's associated web site provider NBC.com would be the “Supplemental Data Content Provider” (106).

A typical embodiment of this invention would be for the Supplemental Data Content Provider (106), in addition to creating the above mentioned traditional sets of web pages (107) for Internet users, would also create a set of Data Pages (108), possibly in a form similar to web pages, that are separate and additional to the set of traditional Internet web pages. These additional Data Pages (108) would typically be accessed only by an Enhanced Television Receiver (112) described in this invention, although it is appreciated that an ordinary web browser might also be able to retrieve the pages if the URL was provided to the browser. However, in the case of an ordinary web browser accessing a data page, since that browser and system would probably lack the capability to interpret the video-hole-cutter directive in the data page, nor have the associated compositing mechanism described in this disclosure, the broadcast video would not be viewable within the data page when displayed by the browser.

Since the Enhanced Television Receiver (112) described in this disclosure has both a Television Broadcast Signal Input(s) (113) and an Internet Connection (115), when the user chooses a broadcast program through an on-screen program guide (described in more detail in subsequent sections of this disclosure), the TV Tuner (114), which could also be referred to as a Broadcast Media Receiver, in the Enhanced Television Receiver (112) would access the broadcast audio/video content via the Television Broadcast Signal Input(s) (113), and the receiver's Internet Access Subsystem (116) would also retrieve the related Data Pages (108) via the Internet (109) and the Internet Connection (115) on the Enhanced TV Receiver (112).

Each of the Data Pages (108) accessed by the receiver would be combined/composited (as described in other sections of this disclosure) by the Compositing Mechanism (117) in the Enhanced TV Receiver (112) and displayed on the receiver's associated Receiver Display (120).

Referring to FIG. 2, “Supplemental Data and Related Data Flow”, the Data Pages (203), which might be similar in form or construction to traditional Internet web pages, would contain information that supplements and complements the television broadcast programming. As an example, for a sporting event, supplemental data might include statistics in the form of text, graphics, pictures in the form of .jpg images, applications, applets, plug-ins, streaming video from additional cameras at the sports venue, and/or supplemental audio files.

However, each Data Page, an example of which is shown in item 204, would also include an indicator, sometimes referred to as a video placeholder or “video hole cutter” (205), that specifies the location within the page where the broadcast video should be combined and placed within the image by the Receiver's Compositing Mechanism (210).

The Compositing Mechanism (210) in the receiver would combine elements of the Data Page (204, 217) along with all or part of the broadcast video (209) as specified by the layout information and Video Hole Cutter (205) region in the Data Page (204), and such combined representation would ultimately be presented to the viewer on the Receiver Monitor (214).

A typical embodiment and presentation to the viewer would consist of the broadcast video with the supplemental data placed around, above, below, aside or even on top of the broadcast video. Some example display images are shown in FIG. 2, item 214 and in FIG. 6, “Example Enhanced Displays.”

If the supplemental data happens to also include audio, that supplemental audio would also be optionally combined with Broadcast Audio (209) coming from the TV tuner (208) by the Compositing Mechanism (210) and presented to the user on the receiver's Audio Speakers (213) or equivalent audio subsystem. That audio would perhaps be mixed with the broadcast audio or presented to the viewer as an alternative to the broadcast audio.

In a typical embodiment, the set of Data Pages for a particular program would have a Main Data Page (215) that the Enhanced TV Receiver initially accesses when the viewer chooses that particular television program to watch. The receiver determines the Internet location of the Main Data Page (215) via a URL (Internet Universal Resource Locator) included in the program guide as described in other sections of this disclosure.

Referring to FIG. 6, Example Enhanced Displays, an example view that would be displayed when the Main Data Page is accessed is the Main Menu View (601). Just as a computer user interacts with a web site's main page by clicking on links to view other information, the enhanced television viewer, using a remote control, can click on icons/links such as those shown on the right portion of the Main Menu View (601) (Game Summary, Other Scores, et cetera) to access information in other Data Pages in order to view other pages of content (602-605) related to the broadcast program being viewed. The icons/links, at the discretion of the page author, could also access other resources on the Internet in general.

Referring to both FIG. 2 (“Supplemental Data and Related Data Flow”) and FIG. 6 (“Example Enhanced Displays”), a typical embodiment would also include at least one Data Page with minimal or no supplemental information included. An example of the resulting view is the “Full Screen Video View” (602). In this case, the “video hole cutter” in the Data Page fills all (or nearly all) of the page, thereby specifying to the Compositing Mechanism (210) in the Enhanced TV Receiver (206) that the broadcast video should fill all (or nearly all) of the display area for users who choose not to view any (or minimal) supplemental information at that particular time.

In the case where minimal supplemental information is included, such information may simply be a “Main Menu” icon (606), and if the user clicks on that icon, another screen with video and a more extensive set of icons and options would then be displayed.

Also, in a typical embodiment, the Supplemental Data Content Provider (201) would “refresh” the pages periodically during the broadcast of the associated television program so that the viewer would experience a current and dynamic display even if the user does not take any action to update the display or chooses not to click on an Icon/Link (219) in the display. For example, during a football game broadcast, if an official video review occurs, the Supplemental Data Content Provider could refresh the screen to show a smaller “main broadcast” window, plus two or three additional video inserts that show the various replay camera angles the officials are examining.

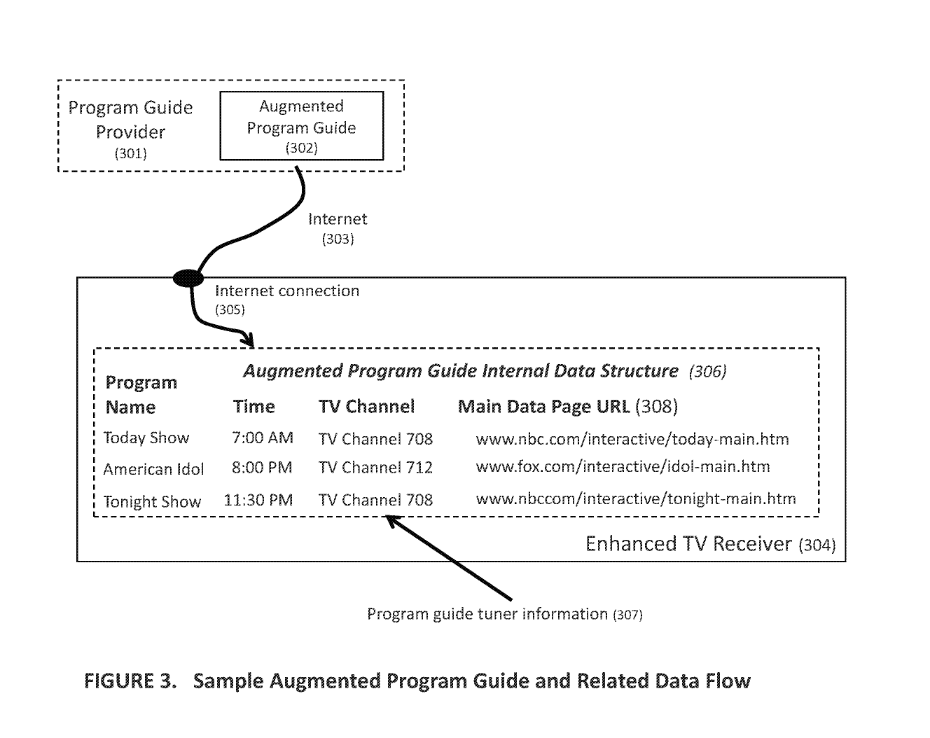

Referring to FIG. 3, “Sample Augmented Program Guide and Related Data Flow”, another element of this invention, the Augmented Program Guide (302) provided by the Program Guide Provider (301), is disclosed in the next few sections.

An on-screen program guide, provided by a program guide provider such as Tribune Media Services, is now a common tool available to television viewers. A typical program guide lists all currently-available (and future) programs that may be viewed. For each program listing, a program guide typically specifies: (1) the Program Name, for example “The Today Show”, (2) the local time at which the program will be broadcast, and (3) the broadcast TV Channel number to which the receiver should tune in order to access the broadcast programming in the viewer's geographical location, for example channel 708.

This invention specifies an extension to the data structure of an existing program guide by a Program Guide Provider (301). The resulting program guide—an Augmented Program Guide (302), containing an Augmented Program Guide Internal Data Structure (306)—would include an additional data element for each program listing, the Main Data Page URL (Universal Resource Locator) (308). This is the Internet address where the Enhanced Television Receiver (304) may access, via the Internet, the Main Data Page (previously described, FIG. 2, item 215) corresponding to that particular broadcast program. Embodiments of the invention may use standard Internet URLs (as specified, for example, in Request for Comments document number 1738), or identifiers of similar functionality but different form, which are particularly adapted for use in an enhanced TV receiver.

Referring momentarily to FIG. 1, the Supplemental Data Content Provider (106) would typically supply the Main Data Page URL (125) for each program listed in the guide to the Program Guide Provider (110). The Program Guide Provider (110) would then incorporate the URL information into the Augmented Program Guide (111).

Continuing the example above, and referring to FIGS. 2 and 3, if the viewer were to choose the “Today Show” via the program guide screen on the receiver monitor (not shown), the TV Tuner (208) on the Enhanced TV Receiver (206) would tune to broadcast channel 708, and the Internet Access Subsystem (211) on the receiver would access the Main Data Page (215) related to the Today Show at URL www.nbc.com/interactive/today-main.htm (308).

The Main Data Page (215) at this URL location would be downloaded by the Enhanced Television Receiver (206) and utilized as described in previous sections of this disclosure.

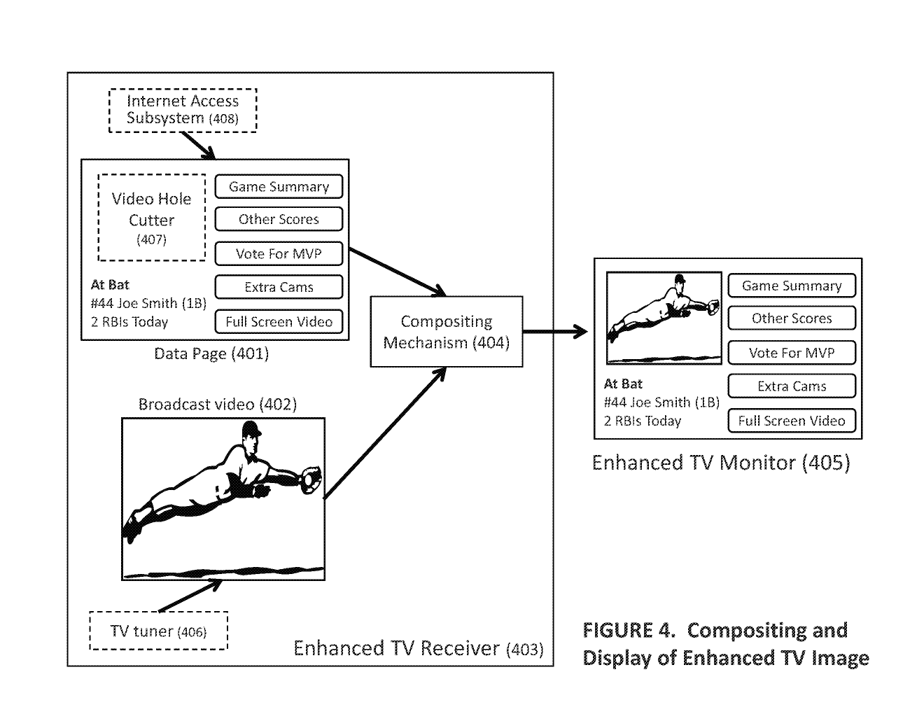

FIG. 4. “Compositing and Display of Enhanced TV Image”, demonstrates how Broadcast Video (402) supplied via the TV Tuner (406) and a Data Page (401) supplied via the Internet Access Subsystem (408) may be combined by the Compositing Mechanism (404) of the Enhanced TV Receiver (403) resulting in a combined image shown on the Enhanced TV Monitor (405).

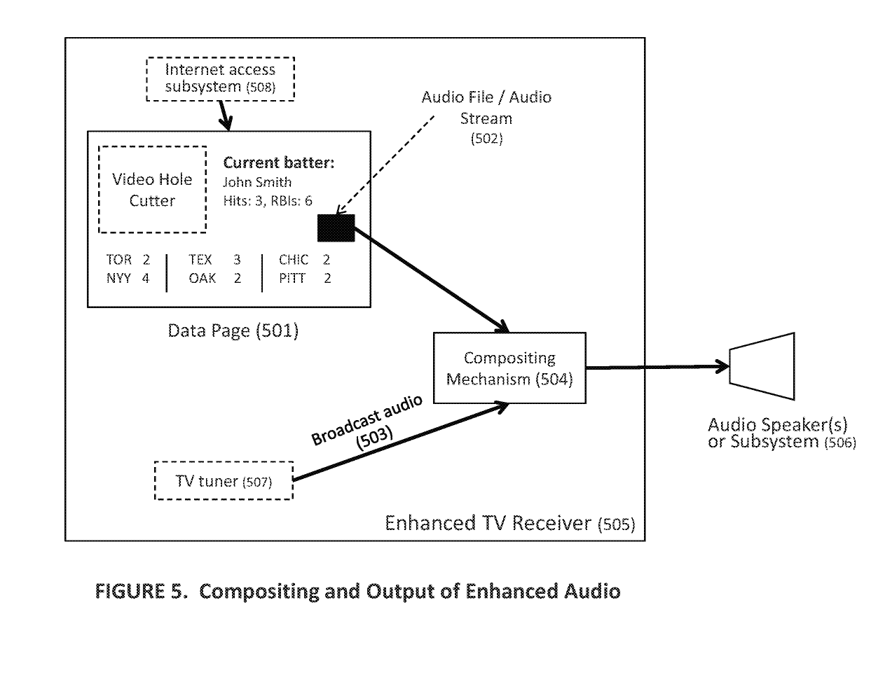

FIG. 5, “Compositing and Output of Enhanced Audio”, demonstrates how Broadcast Audio (503) supplied via the TV Tuner (507) and audio from an Audio File or Audio Stream (502) associated with a Data Page (501) may be combined by the Compositing Mechanism (504) of the Enhanced TV Receiver (505) and presented to the user on the Enhanced TV Audio Speakers or Subsystem (506). Per instructions embedded within the supplemental data page, or per remote control inputs from a user's remote control, the resulting audio may be a mix of broadcast and supplemental sound or one of the two sound sources presented exclusively to the user.

FIG. 6, “Example Enhanced Displays”, show an example set of enhanced displays made possible by this invention and presentable to a viewer. The Main Menu View (601) might be one analogous to the Main Data Page (FIG. 2, 215). This page has the broadcast video shown in a hole cutter region at the top left of the display along with icons/links on the right which allow the user to choose different views that are instantiated by the various available Data Pages (203) provided by the Supplemental Data Content Provider (201).

The other example views are: (1) the Full Screen Video View (602) with minimal supplemental data displayed for the reasons described previously, (2) the Scores View (603) which shows current scores in other games, (3) the Voting View (604) which allows viewers to vote for a favorite player, and (4) an Extra Cameras View (605) where video from other cameras, not being currently broadcast, are sent via Internet to the Enhanced TV Receiver and shown to the viewer.

The latter four example views include a “Main Menu” icon (606) which, when selected by the viewer, causes the Main Menu View (601) to again be displayed.

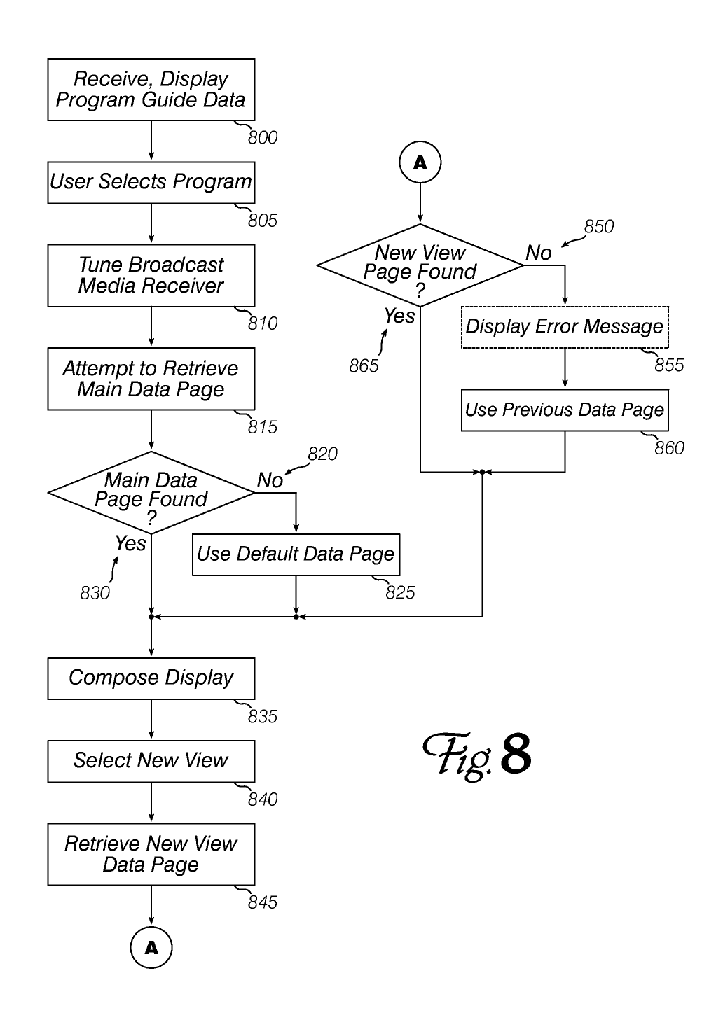

FIG. 8 outlines some operations performed by an embodiment of the invention. At 800, the system receives program guide data (which comprises schedule, channel, and main data page URL) and displays some of that data to the viewer. (It is unlikely to be necessary to display the main data page URL to the viewer at this time, although this option may be provided for an interested viewer to access the URL.) After the user selects a program (805), perhaps by using a remote control to navigate a menu/schedule, the system tunes to the channel listed in the selected program guide entry (810). The system also attempts to retrieve the main data page at the URL in the entry (815). If the main data page cannot be found (820), a default main data page may be substituted (825). Otherwise (830) the retrieved page is used.

As described elsewhere, compositing logic of the system prepares a display image by combining some or all of the broadcast video with portions of the main data page (835), and the image is presented on a monitor (or perhaps sent via a composite video, S-video, HDMI or other connection to a separate display device). Later, while watching the program, the viewer may select a new view (840). (Alternatively, the system may automatically switch to a new view, either on a temporal schedule or in response to a command sent via the Internet or sent in the audio/video data stream.) The system attempts to retrieve the data page describing the new view (845), and if the data page is found (865), it is used to control the composition of a new display image (835). If it is not found (850), an error message may be presented to the user (855), and the data page describing the previous view is re-used (860).

Referring to FIG. 1, this invention disclosure describes one possible embodiment where the Enhanced TV Receiver is itself comprised of two physical receivers and associated connectors/inputs: (1) a TV tuner (114) (which could also be considered a “receiver” or “broadcast media receiver”) with an associated Television Broadcast Signal Input (113), and (2) an Internet Access Subsystem (116) (that could also be viewed as an Internet data “receiver”) with an associated Internet Connection (115). In this configuration, broadcast data is accessed by the TV “receiver”, and both the supplemental data and the program guide data are accessed by the Internet “receiver”.

In general, however, there are three logical data streams used by this invention: (1) the broadcast data stream containing the broadcast audio and video, (2) the supplemental data stream containing the Data Pages, and (3) the program guide data stream containing program guide data. Embodiments are possible where various logical streams may be accessed by various physical receivers and connectors, or perhaps by only one physical receiver and associated connector.

For example, the program guide logical data stream could be sent to the receiver in association with the broadcast data stream and accessed via the TV broadcast receiver. Alternately, if the receiver is connected to a TV cable carrying both a broadcast data stream and TCP/IP Internet traffic, the broadcast stream, supplemental data stream and program guide data stream could all be accessed through a single TV cable and TV cable connector.

As another example, if Internet multicast capabilities, server capacities and bandwidth capabilities increase dramatically in the future, the broadcast data stream could also be delivered to an Enhanced TV Receiver in IP (Internet Protocol) form via the Internet rather than via typical existing television broadcast methods. This invention does not restrict that flexibility of implementation.

Referring to FIG. 1, this disclosure also describes a sample embodiment with a single physical receiver apparatus (the Enhanced TV Receiver (112)) and a separate Receiver Monitor (120). Other embodiments are possible.

In one alternate embodiment, the Enhanced TV Receiver and Receiver Monitor could be integrated into a single apparatus.

In another alternate embodiment, the Enhanced TV Receiver (112) could consist of two physically separate units. For example, some of the capabilities of the Enhanced TV Receiver described herein could be in an intelligent set top box, for example one manufactured by TiVo Corporation, and the output of that set top box could be sent to a less intelligent traditional television receiver, with an integrated (or non-integrated) monitor, that would act as a more passive display device. This invention does not restrict that flexibility of implementation.

This invention has been described largely by reference to specific examples and with specific allocations of functionality to certain hardware and/or software components. However, those of skill in the art will recognize the broad nature of the invention and would readily be able to implement the invention by various similar and/or equivalent methods other than those, or partially the same as described in this disclosure. Such variations and implementations are understood to be captured according to the following claims.

I claim:

1. An enhanced TV appliance comprising:
receiving means to receive at least three logical data streams, a first of the at least three logical data streams comprising broadcast audio data and broadcast video data, a second of the at least three logical data streams comprising data pages, and a third of the at least three logical data streams comprising program guide data; and
a compositing system to construct a display image including at least a portion of the broadcast video data and at least a portion of a data page, said constructing occurring according to the data page,
wherein the program guide data comprises entries for a plurality of programs, each such entry including a scheduled broadcast time for a program, a broadcast channel for the program, and a Uniform Resource Locator (“URL”) for a main data page for the program.

2. The enhanced TV appliance of claim 1, further comprising:
a monitor to present the display image to a viewer.

3. The enhanced TV appliance of claim 1 wherein the main data page for the program specifies a video hole-cutter region, and wherein
the compositing system is to place at least a portion of the broadcast video data into the display image at a position specified by the video hole-cutter region of the main data page.

4. The enhanced TV appliance of claim 1 wherein the receiving means is two receivers, and wherein:
a first of the two receivers obtains the broadcast audio data and broadcast video data and the program guide data from a broadcast signal; and
a second of the two receivers obtains the data pages from the Internet via a Transmission Control Protocol/Internet Protocol (“TCP/IP”) connection.

5. The enhanced TV appliance of claim 4 wherein the broadcast signal is one of a terrestrial television signal, a satellite television signal, or a cable television signal.

6. The enhanced TV appliance of claim 4 wherein the TCP/IP connection is made over one of an Ethernet physical-layer connection or a WiFi physical-layer connection.

7. The enhanced TV appliance of claim 1 wherein the receiving means is two receivers, and wherein:
a first of the two receivers obtains the broadcast audio data and broadcast video data from a broadcast signal; and
a second of the two receivers obtains program guide data and the data page from the Internet via a Transmission Control Protocol/Internet Protocol (“TCP/IP”) connection.

8. The enhanced TV appliance of claim 1 wherein the receiving means is three physical receivers, and wherein each of the three logical data streams is received by a different physical receiver.

9. The enhanced TV appliance of claim 1 wherein the receiving means is one physical receiver, and wherein each of the three logical data streams is extracted from a composite signal obtained by the one physical receiver.

10. The enhanced TV appliance of claim 1, further comprising:
a remote-control receiver to receive a command from a viewer, wherein said command is to cause the receiving means to retrieve an alternate data page and to construct a new display image including at least a portion of the broadcast video data and at least a portion of the alternate data page, said constructing occurring according to the alternate data page.

11. The enhanced TV appliance of claim 1 wherein at least two logical data streams comprise audio data, and wherein
a configurable mix of the audio data from the at least two logical data streams is emitted by the appliance.

12. An audio/video compositing and display system comprising:
a program guide data interpreter to extract a broadcast channel identifier and a corresponding Internet Uniform Resource Locator (“URL”) for a program listed in the program guide;
a media receiver to obtain broadcast audio data and broadcast video data from the identified broadcast channel;
Internet access logic to retrieve a data page identified by the Internet URL, said data page including a video hole-cutter region definition;
compositing logic to prepare a display image including some material from the data page and some of the video data received by the media receiver, said preparing to be controlled by the video hole-cutter region definition;
audio mixing logic to master an audio signal for reproduction, said audio signal comprising some of the broadcast audio data received by the media receiver, said mastering to be controlled by the data page;
a monitor to present the display image to a viewer; and
a speaker to emit the audio signal to the viewer.

13. The audio/video compositing and display system of claim 12, further comprising:
user-interface logic to accept a command from the viewer, said command to cause the Internet access logic to retrieve an alternate data page, wherein
the compositing logic is to prepare a different display image consisting of some material from the alternate data page and some of the broadcast video data.

14. The audio/video compositing and display system of claim 12, further comprising:
user-interface logic to accept a command from the viewer, said command to cause the Internet access logic to retrieve an alternate audio feed, wherein
the audio mixing logic is to master a different audio signal for reproduction, said different audio signal comprising audio data from the alternate audio feed.

15. A method for an enhanced TV receiver operation, comprising:
receiving program guide data from a program guide provider, said program guide data including a plurality of entries, each entry including a scheduled time, a scheduled channel and a main data page locator;
receiving a user's selection of a program guide entry;
tuning a broadcast media receiver to receive broadcast audio data and broadcast video data on the scheduled channel of the selected program guide entry;
signaling Internet access logic to retrieve a main data page identified by the main data page locator of the selected program guide entry;
preparing a display image by compositing the video data received by the broadcast media receiver according to information in the main data page; and
sending the display image to an output device.

16. The method of claim 15, further comprising:
if the main data page cannot be retrieved, using a default main data page to control the preparing operation.

17. The method of claim 16 wherein the default main data page contains a specification to cause the broadcast video data received by the broadcast media receiver to occupy substantially all of the display image.
